(19) United States
(12) Patent Application Publication
(10) Pub. No.: US 2006/0279085 A1
(43) Pub. Date: Dec. 14, 2006

(54) Portable electrical device with dynamic battery recharging

(76) Inventor: Kenneth Lee, New Territories (CN)

Correspondence Address: ALIX YALE & RISTAS LLP, 750 MAIN STREET, SUITE 1400, HARTFORD, CT, 06103, US

(21) Appl. No.: 11/444,692

(22) Filed: Jun. 1, 2006

(30) Foreign Application Priority Data
Jun. 8, 2005 (HK) HK1073226

(51) Int. Cl. F02B 63/04; F02B 67/04

(52) U.S. Cl. 290/1 E

(57) ABSTRACT

A portable handheld electrical device such as a radio or torch includes a rechargeable battery. A dynamo is electrically connected to the battery. A spring-loaded pulley mechanically connects to the dynamo and a pull-string is wrapped about the pulley and extends from the electrical device for reciprocal pulling from and retraction upon the pulley to cause activation of the dynamo to recharge the battery.

### BACKGROUND OF THE INVENTION

The present invention relates to portable devices such as handheld radios and torches. More particularly, although not exclusively, the invention relates to such or other devices having rechargeable batteries and a means for conveniently recharging the batteries without the use of an external plug pack or transformer.

Known handheld devices such as portable radios have used rechargeable batteries for quite some time. Depleted batteries can be removed and placed in a recharging station for replenishment, or an external plug pack can be attached to the devices for recharging purposes. Such recharging is often unfeasible such as for example in the field where no power source is available.

### OBJECTS OF THE INVENTION

It is an object of the present invention to overcome or substantially ameliorate the above disadvantage and/or more generally to provide a portable electrical device having a dynamic battery recharging capability.

### DISCLOSURE OF THE INVENTION

There is disclosed herein a portable handheld electrical device, comprising:
a rechargeable battery,
a dynamo electrically connected to the battery,
a spring-loaded pulley mechanically connected to the dynamo, and
a pull-string wrapped about the pulley and extending from the electrical device for reciprocal pulling from and retraction upon the pulley to activate the dynamo to recharge the battery.

Preferably, the device further comprises a gear mounted co-axially with respect to the pulley and a pinion in mesh with the gear, the pinion mounted on a shaft to which operative parts of the dynamo are mounted.

Preferably, the device further comprises a ratchet mechanism cooperating with the gear and pulley so that rotation of the pulley in one direction only causes rotation of the gear.

### BRIEF DESCRIPTION OF THE DRAWINGS

A preferred form of the present invention will now be described by way of example with reference to the accompanying drawings, wherein:

FIG. 1 is a schematic cross-sectional elevation of a handheld device,

FIG. 2 is a schematic parts-exploded perspective illustration of key internal components of the handheld device of FIG. 1,

FIG. 3 is a schematic illustration of a pulley including an internal spring in an unwound state,

FIG. 4 is a schematic illustration of the pulley showing the internal spring in a loaded/wound state,

FIG. 5 is a schematic elevation of a dynamo,

FIG. 6 is a schematic circuit diagram,

FIG. 7 is a schematic diagram of a raw waveform generated by the dynamo of FIG. 5,

FIG. 8 is a schematic diagram of a waveform modified by the circuit of FIG. 6,

FIG. 9 is a schematic perspective illustration of the key internal components of the handheld device,

FIG. 10 is a schematic perspective illustration of the components of FIG. 9 installed within a casing of a device such as a portable radio,

FIG. 11 is a schematic illustration of a torch embodying the present invention, and

FIG. 12 is a schematic cross-sectional elevation of the torch of FIG. 11.

### DESCRIPTION OF THE PREFERRED EMBODIMENTS

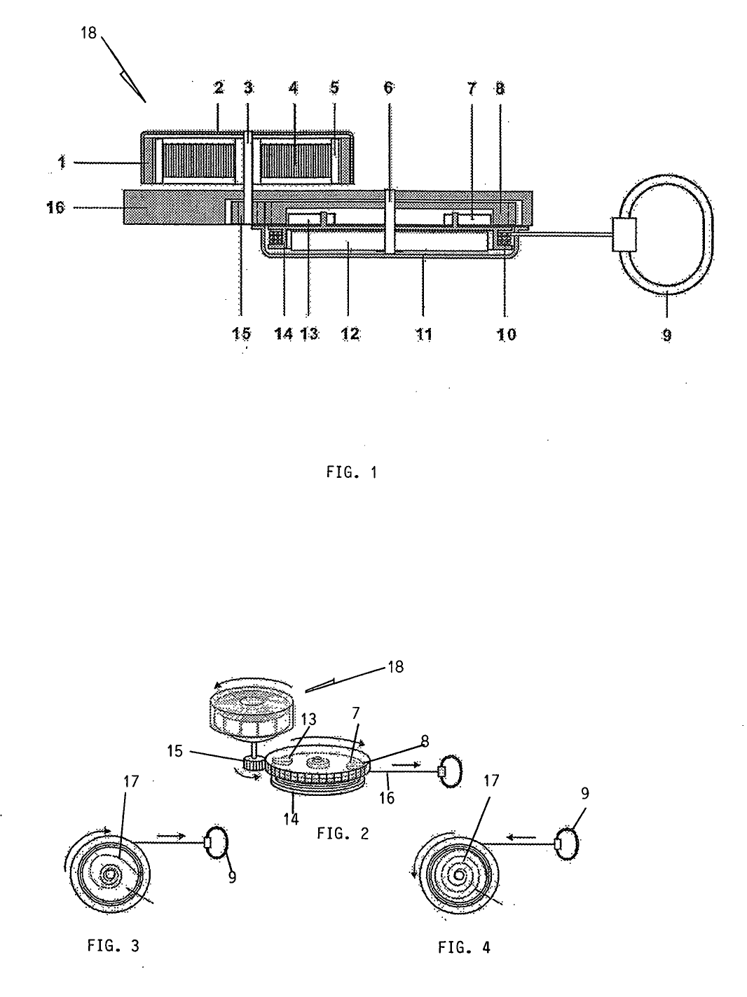

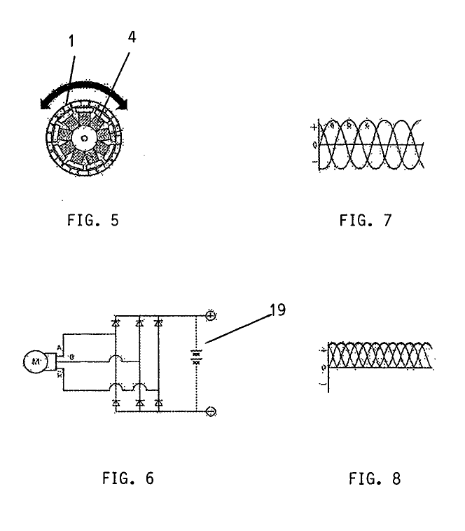

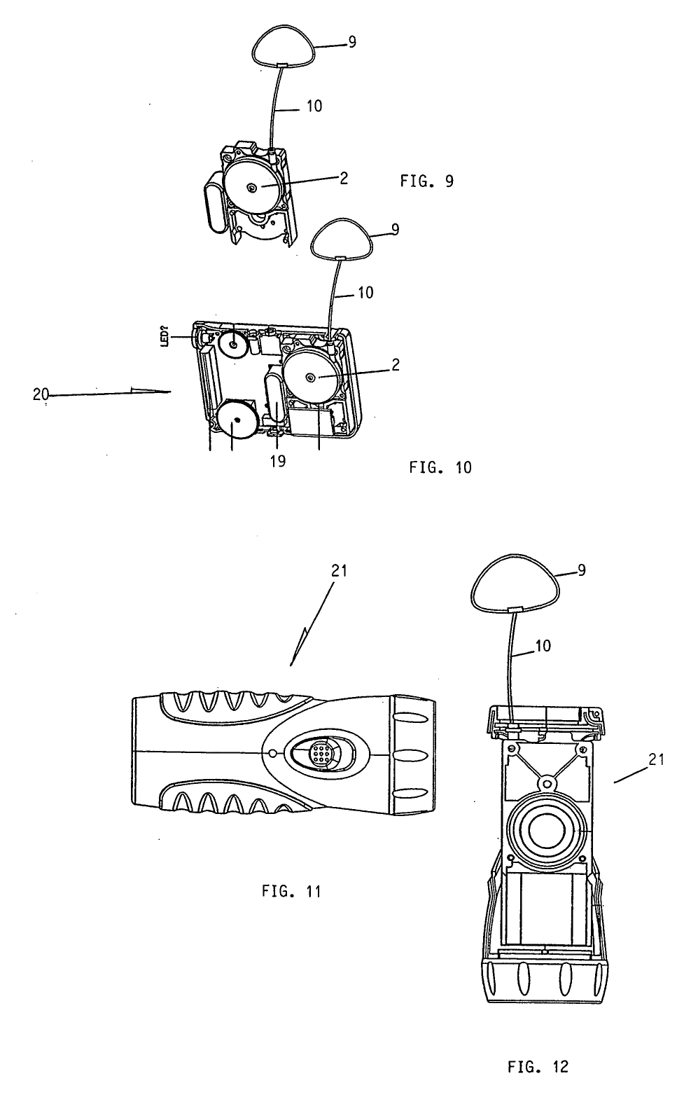

In FIG. 1 of the accompanying drawings there is depicted schematically a chassis 16 comprising a casing 11 housing an axle 6 upon which a pulley 14 and a gear 8 are mounted. Ratchets 7 and 13 are mounted upon pins to ensure that rotation of the pulley 14 in only one direction causes rotation of the gear 8. A flywheel 12 is attached to the axle 6. Wrapped around the pulley 14 is a string 10 having a pulling ring 9 at its distal end. Mounted upon another axle 3 is a pinion 15 that is in mesh with the gear 8. Surrounding the axle 3 is a dynamo coil 4 located within a support frame 5 which supports a permanent magnet 1. These features are housed within a rotary casing 2 which is fixed upon the shaft 3 to rotate in unison with the pinion 15. Electrical terminals (not shown) would be provided at the dynamo coil 4.

There is a coil spring 17 attached internally to the pulley 14 having an inner end fixed to the axle 6 and an outer end attached to the pulley. Upon pulling of the string 10, the coil spring loads up as shown in FIG. 4 such that release of tension from the string will result in it been retracted about the pulley for further pulling.

Electrical terminals of the coil 4 are connected to the circuit shown in FIG. 6. This simple diode circuit is adapted to convert the raw alternating current generated by the dynamo and as shown in FIG. 7 into a direct current as shown in FIG. 8 for recharging the batteries 19.

As shown in FIG. 10, the invention can be embodied in a portable radio 20. As shown in FIGS. 11 and 12, the invention might be embodied in a torch 21. Alternatively, the invention can be embodied in any handheld device that might operate with rechargeable batteries.

It should be appreciated that modifications and alterations obvious to those skilled in the art are not be considered as beyond the scope of the present invention. For example, in order to make a more compact device, the dynamo and pulley might be configured co-axially in which case the gear 8 might have inwardly facing teeth.

1. A portable handheld electrical device, comprising:
a rechargeable battery,
a dynamo electrically connected with the battery,
a spring-loaded pulley mechanically connected to the dynamo, and
a pull-string wrapped about the pulley and extending from the electrical device for reciprocal pulling from and retraction upon the pulley to activate the dynamo to recharge the battery.

2. The device of claim 1, further comprising a gear mounted co-axially with respect to the pulley and a pinion in mesh with the gear, the pinion mounted on a shaft to which operative parts of the dynamo are mounted.

3. The device of claim 2, further comprising a ratchet mechanism cooperating with the gear and pulley so the rotation of the pulley in one direction only causes rotation of the gear.
